(19) United States
(12) Patent Application Publication
(10) Pub. No.: US 2013/0039439 A1
(43) Pub. Date: Feb. 14, 2013

(54) MULTICARRIER TRANSMITTING APPARATUS AND MULTICARRIER TRANSMITTING METHOD

(71) Applicant: Jun KAMEYA, Kawasaki (JP)

(72) Inventor: Jun KAMEYA, Kawasaki (JP)

(73) Assignee: FUJITSU LIMITED, Kawasaki-shi (JP)

(21) Appl. No.: 13/534,149

(22) Filed: Jun. 27, 2012

(30) Foreign Application Priority Data
Aug. 9, 2011 (JP) 2011-174417

(51) Int. Cl. H04L 27/00

(52) U.S. Cl. 375/295

(57) ABSTRACT

A multicarrier transmitting apparatus includes a subcarrier mapping unit, an IFFT unit, and a signal transformation value separation unit. When the subcarrier mapping unit transmits first reference signals and second reference signals continuous in the time axis direction, the subcarrier mapping unit outputs a multicarrier signal in which the first reference signals and the second reference signals are allocated to subcarriers continuous in the frequency axis direction. The IFFT unit performs an inverse Fourier transformation on the multicarrier signal output from the subcarrier mapping unit to output signal transformation values in the time axis direction. The signal transformation value separation unit separates the signal transformation values output from the IFFT unit into signal transformation values associated with subcarriers to which the first reference signals are allocated and signal transformation values associated with the subcarriers to which the second reference signal are allocated.

### CROSS-REFERENCE TO RELATED APPLICATION

This application is based upon and claims the benefit of priority of the prior Japanese Patent Application No. 2011-174417, filed on Aug. 9, 2011, the entire contents of which are incorporated herein by reference.

### FIELD

The embodiment discussed herein is directed to a multicarrier transmitting apparatus and a multicarrier transmitting method.

### BACKGROUND

Conventionally, wireless communication systems use multicarrier transmitting apparatuses, such as mobile terminals. In recent years, there has been continuous development of Long Term Evolution (LTE), a high-speed data communication standard that is part of the 3rd Generation Partnership Project (3GPP). When a multicarrier transmitting apparatus that uses LTE transmits a signal to an external unit, such as a base station, the multicarrier transmitting apparatus transmits the signal by using various types of physical channels. Examples of the physical channels include a physical uplink control channel (PUCCH), a physical uplink shared channel (PUSCH), and physical random access channel (PRACH).

Furthermore, if the multicarrier transmitting apparatus that uses LTE previously estimates the state of an uplink physical channel, the multicarrier transmitting apparatus transmits various types of reference signals. Examples of the reference signals include a demodulation reference signal (DRS) and a sounding reference signal (SRS). If the multicarrier transmitting apparatus transmits, for example, SRSs, the multicarrier transmitting apparatus allocates the signals to subcarriers that are continuous in the frequency axis direction; performs an inverse Fourier transformation (IFFT) on the allocated signals; and obtains signal transformation values continuous in the time axis direction.

Patent Document 1: Japanese National Publication of International Patent Application No. 2010-520699

However, with the above described conventional technology that uses LTE, there is a problem in that, if two continuous reference signals are transmitted, the load applied to the inverse Fourier transformation increases.

For example, in LTE, there may be a case in which 2-symbol SRSs are transmitted as reference signals. In such a case, with the conventional technology, an IFFT is performed on each SRS. Specifically, with the conventional technology, SRSs having a first symbol are allocated to subcarriers, the allocated signals are subjected to the IFFT, and signal transformation values are obtained. Then, SRSs having a second symbol are allocated to subcarriers, the allocated signals are subjected to the IFFT, and signal transformation values are obtained. In this way, if 2-symbol SRSs are transmitted as the reference signals, the IFFT is performed twice, and thus the load applied to the IFFT increases.

### SUMMARY

According to an aspect of an embodiment of the invention, a multicarrier transmitting apparatus includes a mapping unit that outputs, when first reference signals and second reference signals continuous in the time axis direction are transmitted, a multicarrier signal in which the first reference signals and the second reference signals are allocated to subcarriers continuous in the frequency axis direction; an inverse Fourier transformation unit that performs an inverse Fourier transformation on the multicarrier signal output from the mapping unit to output signal transformation values continuous in the time axis direction; and a signal transformation value separation unit that separates the signal transformation values output from the inverse Fourier transformation unit into signal transformation values associated with subcarriers to which the first reference signals are allocated and signal transformation values associated with subcarriers to which the second reference signals are allocated.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram illustrating the frame structure of LTE;

FIG. 2 is a schematic diagram illustrating the allocation of SRSs in LTE to subcarriers;

FIG. 3 is a schematic diagram illustrating an example of inverse Fourier transformations in LTE obtained when SRSs are allocated to even subcarriers;

FIG. 4 is a schematic diagram illustrating an example configuration of butterfly computing elements illustrated in FIG. 3;

FIG. 5 is a schematic diagram illustrating inverse Fourier transformations in LTE obtained when SRSs are allocated to odd subcarriers;

FIG. 6 is a schematic diagram illustrating allocation of SRSs to subcarriers performed by a wireless communication apparatus according to an embodiment;

FIG. 7 is a schematic diagram illustrating an example of inverse Fourier transformations performed by the wireless communication apparatus according to the embodiment;

FIG. 8 is a schematic diagram illustrating an example configuration of the last stage of the butterfly computing element illustrated in FIG. 7;

FIG. 9 is a block diagram illustrating an example configuration of the wireless communication apparatus according to the embodiment;

FIG. 10 is a block diagram illustrating an example configuration of a transmission processing unit according to the embodiment;

FIG. 11 is a schematic diagram illustrating a process performed by a subcarrier mapping unit;

FIG. 12 is a block diagram illustrating an example configuration of an IFFT computing unit;

FIG. 13 is a schematic diagram illustrating a process performed by a signal transformation value separation unit;

FIG. 14 is a schematic diagram illustrating a process performed by a subcarrier shifting unit;

FIG. 15 is a schematic diagram illustrating a process performed by the subcarrier shifting unit;

FIG. 16 is a flowchart illustrating the flow of a transmission process performed by the transmission processing unit according to the embodiment;

FIG. 17 is a flowchart illustrating the flow of a subcarrier mapping process performed by a subcarrier mapping unit according to the embodiment;

FIG. 18 is a flowchart illustrating the flow of an IFFT process performed by an IFFT unit according to the embodiment;

FIG. 19 is a flowchart illustrating the flow of a separation process performed by a signal transformation value separation unit according to the embodiment; and

FIG. 20 is a flowchart illustrating the flow of a subcarrier shifting process performed by a subcarrier shifting unit and a subcarrier shift determining unit according to the embodiment.

### DESCRIPTION OF EMBODIMENT

Preferred embodiments of the present invention will be explained with reference to accompanying drawings. In the following embodiment, a description will be given of a case in which the multicarrier transmitting apparatus disclosed in the present invention is used in a wireless communication apparatus that uses LTE. The present invention is not limited to the embodiment.

In the 3rd Generation Partnership Project (3GPP), the development of Long Term Evolution (LTE), which is one of the high-speed data communication standards, is continuing. In LTE, if the state of an uplink physical channel is estimated, various kinds of reference signals are transmitted. For example, a reference signal called a sounding reference signal (SRS) is transmitted. In particular, if an SRS is transmitted by using frame structure type 2 (FS2), which is one of the frame structures defined by LTE, 2-symbol SRSs may be sometimes transmitted.

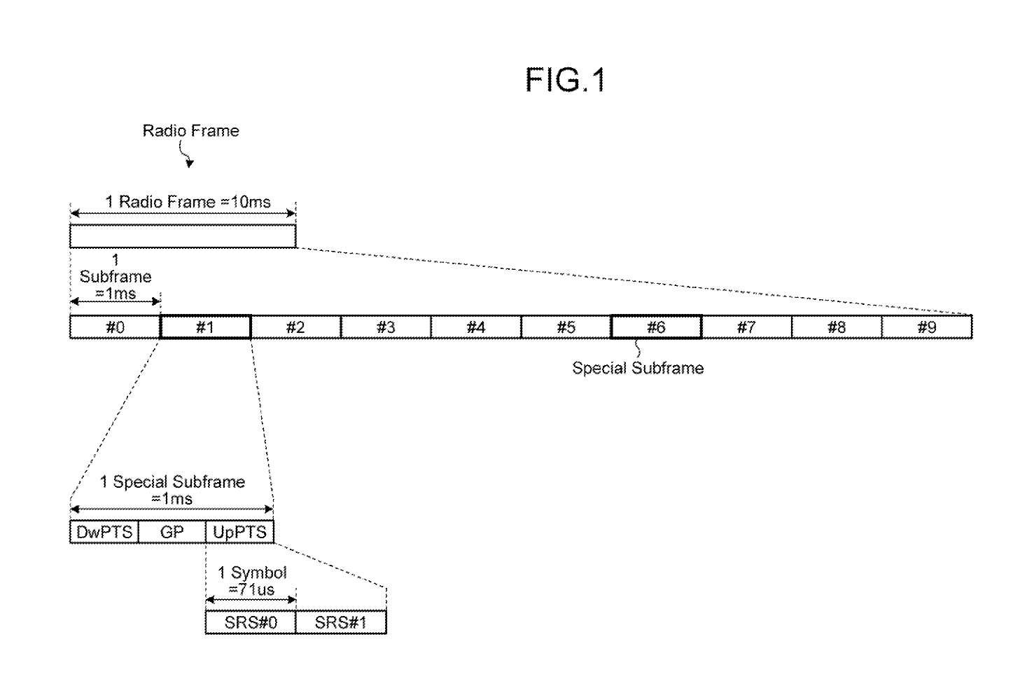

FIG. 1 is a schematic diagram illustrating the frame structure of LTE. FIG. 1 illustrates an example configuration of FS2 from among the frame structures in LTE. In the FS2 illustrated in FIG. 1, a radio frame with a length of 10 ms is divided into ten subframes #0 to #9 with a length of 1 ms. Then, from among the ten subframes #0 to #9, subframes #1 and #6 are defined as special subframes. Specifically, the subframes #1 and #6 each contain three fields, i.e., a downlink pilot time slot (DwPTS), a guard interval (GP), and an uplink pilot time slot (UpPTS). In the UpPTS from among these three fields, a 2-symbol SRS #0 and a 2-symbol SRS #1 are sometimes continuously transmitted.

In the following, before describing the multicarrier transmitting method performed in the wireless communication apparatus according to the embodiment, a description will be given of the underlying multicarrier transmitting method.

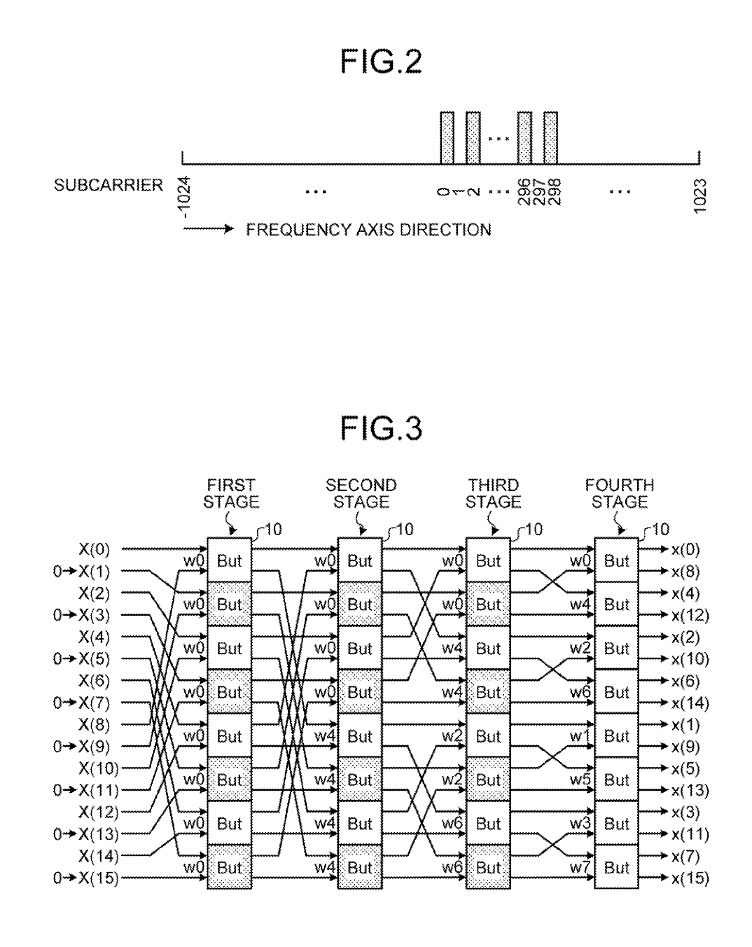

FIG. 2 is a schematic diagram illustrating the allocation of SRSs to subcarriers in LTE. If the wireless communication apparatus that uses LTE transmits SRSs the wireless communication apparatus first allocates transmission data on the SRSs to subcarriers continuous in the frequency axis direction. Specifically, as illustrated in FIG. 2, the wireless communication apparatus allocates, from among the subcarriers, transmission data on the SRSs to subcarriers, whose identification numbers are an even number (hereinafter, referred to as “even subcarriers”) or subcarriers, whose identification number are an odd number (hereinafter, referred to as “odd subcarriers”). Furthermore, “0” is allocated to odd subcarriers if SRSs are allocated to even subcarriers, whereas “0” is allocated to even subcarriers if SRSs are allocated to odd subcarriers.

Subsequently, by using transmission data on SRSs allocated to even subcarriers or odd subcarriers, the wireless communication apparatus performs an inverse Fourier transformation (IFFT) to obtain signal transformation values continuous in the time axis direction.

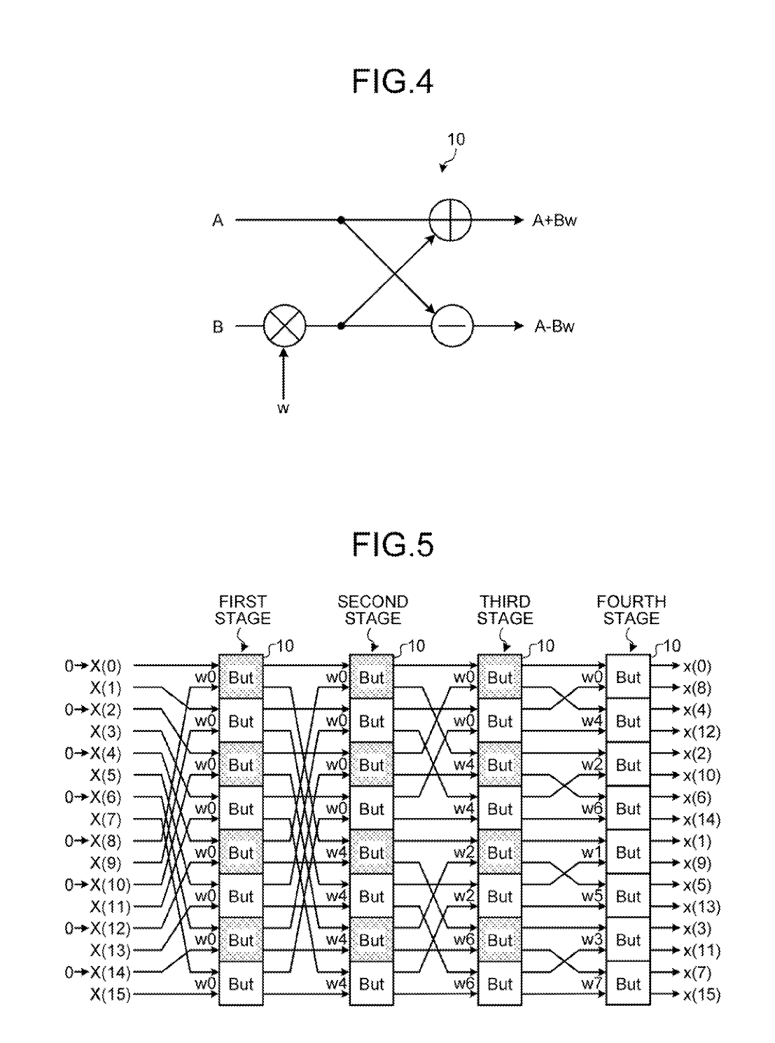

FIG. 3 is a schematic diagram illustrating an example of inverse Fourier transformations in LTE obtained when SRSs are allocated to even subcarriers. FIG. 4 is a schematic diagram illustrating an example configuration of butterfly computing elements (Buts) illustrated in FIG. 3. In FIG. 3, it is assumed that, from among 16 data X(0) to X(15) in the frequency axis direction, the data X(0), X(2), X(4), . . . , and X(14) are transmission data on the SRSs allocated to even subcarriers.

As illustrated in FIG. 3, the wireless communication apparatus includes butterfly computing elements (Buts) 10 having multiple stages (in this case, a first stage to a fourth stage). As illustrated in FIG. 4, in each of the Buts 10, butterfly computation including multiplication by a twiddle factor w and cross calculation is performed. Then, the wireless communication apparatus outputs, as signal transformation values continuous in the time axis direction, 16 computation values x(0) to x(15) that are obtained by performing, in stages, the butterfly computation using the Buts 10 in the first to the fourth stages.

FIG. 5 is a schematic diagram illustrating inverse Fourier transformations in LTE obtained when SRSs are allocated to odd subcarriers. In FIG. 5, it is assumed that, from among 16 data X(0) to X(15) in the frequency axis direction, the data X(1), X(3), . . . , and X(15) are transmission data on the SRSs allocated to odd subcarriers.

As illustrated in FIG. 5, the wireless communication apparatus includes the Buts 10 having multiple stages (in this case, a first stage to a fourth stage). As illustrated in FIG. 4, in each of the Buts 10, butterfly computation including multiplication by a twiddle factor w and cross calculation is performed. Then, the wireless communication apparatus outputs, as signal transformation values continuous in the time axis direction, 16 computation values x(0) to x(15) that are obtained by performing, in stages, the butterfly computation using the Buts 10 in the first to the fourth stages.

In the following, a problem in the multicarrier transmitting method illustrated in FIGS. 2 to 5 will be described. The wireless communication apparatus allocates transmission data on SRSs to even subcarriers or odd subcarriers. Then, “0” is allocated to the odd subcarriers if the SRSs are allocated to the even subcarriers, whereas “0” is allocated to the even subcarriers if the SRSs are allocated to the odd subcarriers.

Accordingly, for example, from among the Buts having multiple stages included in the wireless communication apparatus, an input to some of the Buts becomes “0” and thus an output from the Buts also becomes “0”. Accordingly, unnecessary calculation is performed in the Buts that output “0”. For example, in the example illustrated in FIG. 3, “0” is allocated to the subcarriers X(1), X(3), . . . , and X(15), which are other than the transmission data X(0), X(2), . . . , and X(14) on the SRSs allocated to the even subcarriers. Accordingly, from among the Buts 10 having the first to the fourth stages arranged in the wireless communication apparatus, two inputs to each of the Buts 10 represented by gray become “0” and thus two outputs from each of the Buts 10 represented by gray also become “0”. Accordingly, unnecessary calculation is performed in the Buts 10 represented by gray.

Furthermore, for example, in the example illustrated in FIG. 5, “0” is allocated to the subcarriers X(0), X(2), . . . , and X(14), which are other than the transmission data X(1), X(3), . . . , and X(15) on the SRSs allocated to the odd subcarriers. Accordingly, from among the Buts 10 having the first to the fourth stages arranged in the wireless communication apparatus, two inputs to each of the Buts 10 represented by gray become “0” and thus two outputs from each of the Buts 10 represented by gray also become “0”. Accordingly, unnecessary calculation is performed in the Buts 10 represented by gray.

As described above, if inverse Fourier transformations are performed in the wireless communication apparatus by allocating transmission data on SRSs to even subcarriers or odd subcarriers, unnecessary calculation is performed in some Buts from among Buts having multiple stages in the wireless communication apparatus. In particular, if 2-symbol SRSs are continuously transmitted using an FS2 as defined by LTE, the wireless communication apparatus performs inverse Fourier transformations on each SRS; therefore, inverse Fourier transformations are performed twice. Accordingly, from among the Buts having multiple stages arranged in the wireless communication apparatus, the amount of unnecessary calculation performed by some Buts increases, and thus the load applied to the inverse Fourier transformations increases.

Accordingly, in the embodiment, by effectively using the Buts that perform unnecessary calculation, the load applied to the inverse Fourier transformations is reduced when 2-symbol SRSs are transmitted.

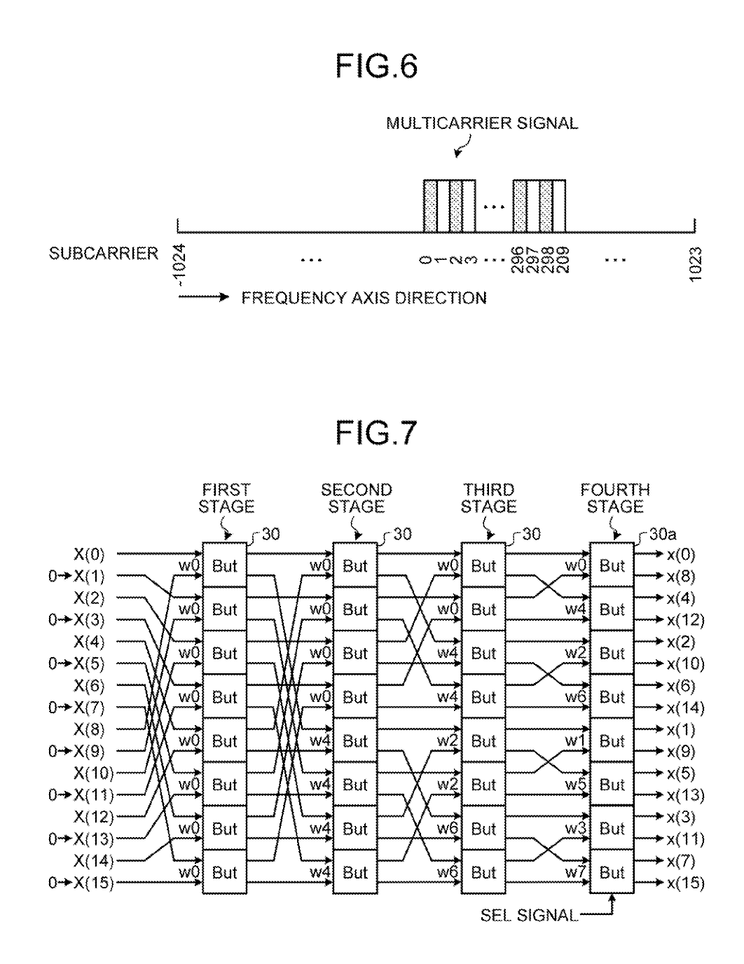

In the following, a multicarrier transmitting method performed by the wireless communication apparatus according to the embodiment will be described. FIG. 6 is a schematic diagram illustrating allocation of SRSs to subcarriers performed by a wireless communication apparatus according to the embodiment.

When the wireless communication apparatus according to the embodiment continuously transmits 2-symbol SRSs the wireless communication apparatus first creates a multicarrier signal in which SRSs having the first symbol and SRSs having the second symbol are allocated to subcarriers continuous in the frequency axis direction. Specifically, first, the wireless communication apparatus creates a multicarrier signal in which the SRSs are allocated to the subcarriers such that the SRSs having the first symbol and the SRSs having the second symbol are alternately arranged in the frequency axis direction. For example, as illustrated in FIG. 6, the wireless communication apparatus allocates transmission data on SRSs having the first symbol represented by gray to the even subcarriers and allocates transmission data on SRSs having the second symbol represented by white to the odd subcarriers, thereby creating a multicarrier signal.

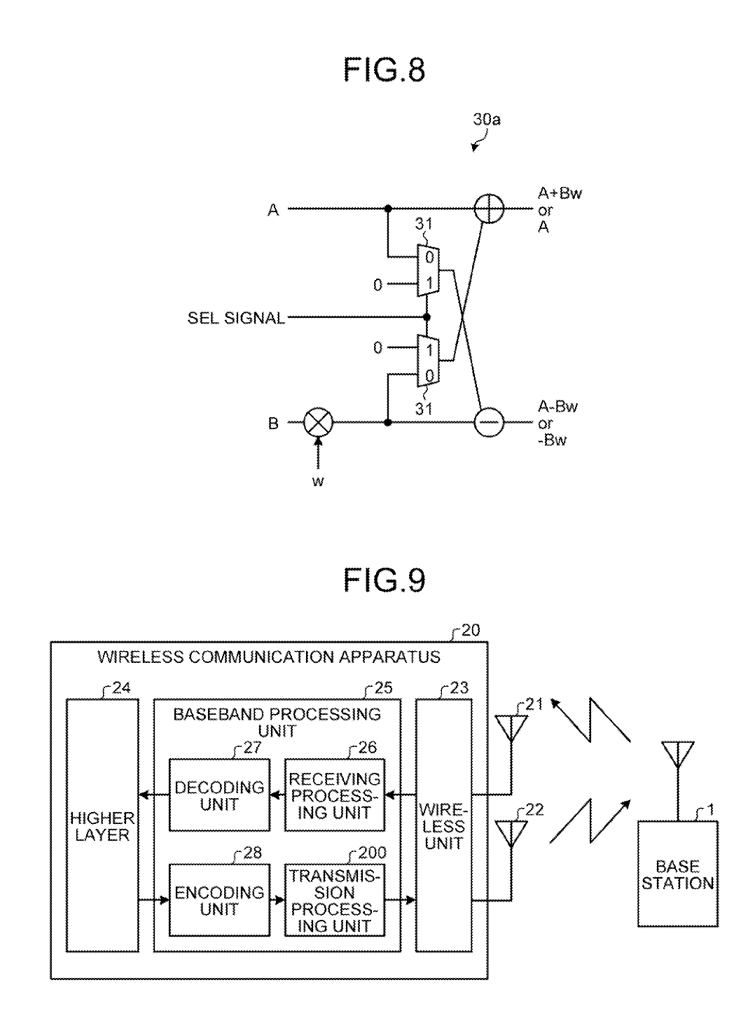

Subsequently, the wireless communication apparatus performs inverse Fourier transformations on the multicarrier signal and obtains signal transformation values continuous in the time axis direction. FIG. 7 is a schematic diagram illustrating an example of the inverse Fourier transformations performed by the wireless communication apparatus according to the embodiment. FIG. 8 is a schematic diagram illustrating an example configuration of the last stage of the butterfly computing element illustrated in FIG. 7. In FIG. 7, it is assumed that the 16 data X(0) to X(15) in the frequency axis direction are transmission data that constitute a multicarrier signal. Furthermore, it is assumed that, from among transmission data constituting the multicarrier signal, the data X(0), X(2), X(4), . . . , and X(14) are transmission data on the SRSs having the first symbol allocated to the even subcarriers. Furthermore, it is assumed that the data X(1), X(3), X(5), . . . , and X(15) are transmission data on the SRSs having the second symbol allocated to the odd subcarriers.

As illustrated in FIG. 7, the wireless communication apparatus according to the embodiment includes butterfly computing elements (Buts) 30 having multiple stages (in this case, the first stage to the fourth stage). In each of the Buts 30 in the first to the third stages, similarly to the Buts 10 illustrated in FIG. 4, normal butterfly computation including multiplication by a twiddle factor w and cross calculation is performed. In contrast, as illustrated in FIG. 8, selectors 31 are arranged in Buts 30a in the fourth stage that is the last stage. Then, the wireless communication apparatus according to the embodiment supplies, to the selectors 31, “0” or “1” as a selection signal (SEL), thereby controlling butterfly computation performed by each of the Buts 30a in the last stage. For example, by supplying “0” to the selectors 31 as a SEL signal in normal operations, the wireless communication apparatus allows the Buts 30a in the last stage to perform the normal butterfly computation. In contrast, if the wireless communication apparatus continuously transmits 2-symbol SRSs, by supplying “1” to the selectors 31 as a SEL signal, the wireless communication apparatus sets computation target data of the butterfly computation performed by each of the Buts 30a in the last stage to “0”. Then, the wireless communication apparatus outputs, as signal transformation values continuous in the time axis direction, 16 computation values x(0) to x(15) obtained by the butterfly computation that is performed by each of the Buts 30a in the last stage and that is performed by using the computation target data of “0” set by the selectors 31. Accordingly, from among signal transformation values x(0) to x(15), first-half signal transformation values x(0) to x(7), which are the first half identification numbers, are signal transformation values associated with the subcarriers to which the SRSs having the first symbol are allocated. In contrast, second-half transformation values x(8) to x(15), which are the second half identification numbers, are signal transformation values associated with the subcarriers to which the SRSs having the second symbol are allocated.

Subsequently, the wireless communication apparatus according to the embodiment separates the signal transformation values continuous in the time axis direction into the signal transformation values associated with the subcarriers, to which the SRSs having the first symbol are allocated, and the signal transformation values associated with the subcarriers, to which the SRSs having the second symbol are allocated. Specifically, from among the signal transformation values continuous in the time axis direction, the wireless communication apparatus concatenates the first-half signal transformation values with the end of the first-half signal transformation values having the first-half identification numbers, and thereby the wireless communication apparatus creates signal transformation values associated with the subcarriers to which SRSs having the first symbol are allocated. Furthermore, the wireless communication apparatus inverts the sign of the second-half transformation values having the second-half identification numbers and concatenates the second-half transformation values with the end of the second-half transformation values whose sign is inverted, and thereby the wireless communication apparatus creates signal transformation values associated with the subcarriers to which the SRSs having the second symbol are allocated. For example, from among the signal transformation values x(0) to x(15) illustrated in FIG. 5, by concatenating the first-half signal transformation values x(0) to x(7) with the end of the first-half signal transformation values x(0) x(7), the wireless communication apparatus creates signal transformation values associated with the subcarriers to which SRSs having the first symbol are allocated. Furthermore, the wireless communication apparatus inverts the sign of the second-half transformation values; concatenates the second-half transformation values x(8) to x(15) with the end of the second-half transformation values −x(8) to −x(15), whose sign is inverted; and thereby creates signal transformation values associated with the subcarriers to which SRSs having the second symbol are allocated.

As described above, if the wireless communication apparatus according to the embodiment continuously transmits 2-symbol SRSs, the wireless communication apparatus obtains signal transformation values by performing inverse Fourier transformations on a multicarrier signal obtained by allocating the 2-symbol SRSs to subcarriers continuous in the frequency axis direction. Then, the wireless communication apparatus according to the embodiment separates the obtained signal transformation values into the signal transformation values associated with the SRSs having the first symbol and the signal transformation values associated with the SRSs having the second symbol. Accordingly, the wireless communication apparatus according to the embodiment can eliminate unnecessary calculation performed in the Buts and reduce the number of times an inverse Fourier transformation is performed from two to one. Consequently, it is possible to reduce the load applied to the inverse Fourier transformations performed when 2-symbol SRSs are continuously transmitted.

In the following, the configuration of the wireless communication apparatus according to the embodiment will be described with reference to FIG. 9. FIG. 9 is a block diagram illustrating an example configuration of the wireless communication apparatus according to the embodiment. A wireless communication apparatus 20 illustrated in FIG. 9 is, for example, a mobile terminal, such as a mobile phone that uses LTE and performs wireless communication with a base station 1. As illustrated in FIG. 9, the wireless communication apparatus 20 includes a receiving antenna 21, a transmitting antenna 22, a wireless unit 23, a higher layer 24, and a baseband processing unit 25.

The receiving antenna 21 is an antenna that receives a signal from outside. For example, the receiving antenna 21 receives signals transmitted from the base station 1. The transmitting antenna 22 is an antenna that transmits a signal to outside. For example, the transmitting antenna 22 transmits a signal to the base station 1. The wireless communication apparatus 20 may also include a transmitting-receiving antenna having the function of both the receiving antenna and the transmitting antenna.

The wireless unit 23 transmits and receives radio signals to/from the transmitting antenna 22 or the receiving antenna 21. For example, the wireless unit 23 performs a wireless process, such as an analog-to-digital (A/D) conversion, on the signals received from the receiving antenna 21. Furthermore, for example, the wireless unit 23 performs a wireless process, such as an analog-to-digital (A/D) conversion, on the signals received from a transmission processing unit 200, which will be described later, and transmits the signals subjected to the wireless process to the base station 1 via the transmitting antenna 22.

If a decoding unit 27, which will be described later, inputs incoming data that is decoded, the higher layer 24 performs various processes in accordance with the incoming data. For example, if the incoming data is email data, the higher layer 24 stores the incoming data in a predetermined storage area.

If the higher layer 24 transmits data to outside, such as the base station 1, the higher layer 24 creates transmission data and outputs the created transmission data to an encoding unit 28. For example, it is assumed that the wireless communication apparatus 20 transmits data by using a physical channel, such as a physical uplink control channel (PUCCH) or a physical uplink shared channel (PUCCH). In such a case, the higher layer 24 creates transmission data in accordance with, for example, the operation performed by a user. Furthermore, for example, it is assumed that the wireless communication apparatus 20 transmits a reference signal, such as a sounding reference signal (SRS) or a demodulation reference signal (DRS). In such a case, the higher layer 24 outputs, for example, a Zadoff-Chusequence number to the transmission processing unit 200.

The baseband processing unit 25 performs a baseband process on the transmission data and the incoming data. As illustrated in FIG. 9, the baseband processing unit 25 includes a receiving processing unit 26, the decoding unit 27, the encoding unit 28, and the transmission processing unit 200.

The receiving processing unit 26 performs various receiving processes on the incoming data received from the wireless unit 23. For example, the receiving processing unit 26 performs a cyclic prefix (CP) deletion process or a demodulation process on the incoming data received from the wireless unit 23. The decoding unit 27 decodes the incoming data received from the receiving processing unit 26.

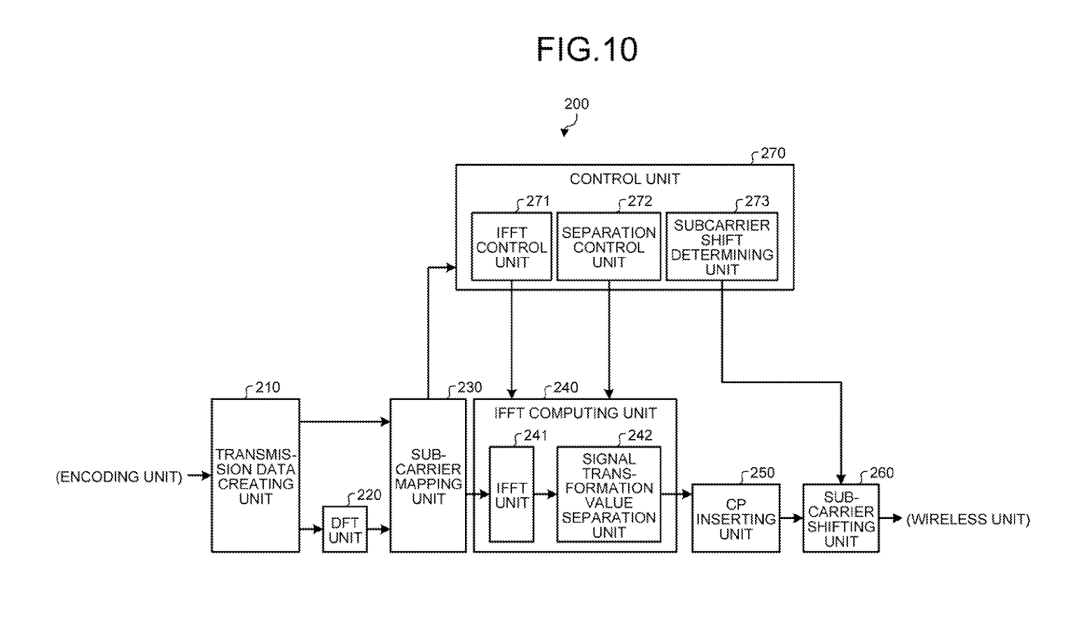

The encoding unit 28 adds an error correction code to transmission data received from the higher layer 24. The transmission processing unit 200 performs various transmission processes on the transmission data to which the error correction code is added by the encoding unit 28. The process performed by the transmission processing unit 200 will be specifically described later with reference to FIG. 10.

In the following, the configuration of the transmission processing unit 200 according to the embodiment will be described with reference to FIG. 10. FIG. 10 is a block diagram illustrating an example configuration of the transmission processing unit 200 according to the embodiment. As illustrated in FIG. 10, the transmission processing unit 200 according to the embodiment includes a transmission data creating unit 210, a DFT unit 220, a subcarrier mapping unit 230, an IFFT computing unit 240, a CP inserting unit 250, a subcarrier shifting unit 260, and a control unit 270.

If a data bit string is input from the encoding unit 28, the transmission data creating unit 210 modulates the data bit string in accordance with an instruction from the higher layer 24 and creates transmission data. For example, if the transmission data creating unit 210 receives an instruction to continuously transmit 2-symbol SRSs from the higher layer 24, the transmission data creating unit 210 creates continuous transmission data containing the 2-symbol SRSs.

Then, the transmission data creating unit 210 outputs the created transmission data to the DFT unit 220 or the subcarrier mapping unit 230. If the transmission data is related to the PUCCH, the SRS, and the DRS, the transmission data creating unit 210 outputs the transmission data to the subcarrier mapping unit 230. In contrast, if the transmission data is related to the PRACH or the PUSCH, the transmission data creating unit 210 outputs the transmission data to the DFT unit 220.

The DFT unit 220 performs Fourier transformations on the transmission data received from the transmission data creating unit 210, thereby converting the transmission data on the time axis to transmission data on the frequency axis. Then, the DFT unit 220 outputs the transmission data on the frequency axis to the subcarrier mapping unit 230.

The subcarrier mapping unit 230 allocates the transmission data received from the transmission data creating unit 210 or the transmission data received from the DFT unit 220 to a subcarrier. If the transmission data are transmission data on the 2-symbol SRSs, the subcarrier mapping unit 230 creates a multicarrier signal by allocating the SRSs having the first symbol and the SRSs having the second symbol to subcarriers continuous in the frequency axis direction. Then, the subcarrier mapping unit 230 outputs the created multicarrier signal to the IFFT computing unit 240.

Furthermore, the subcarrier mapping unit 230 notifies the control unit 270 of available subcarrier information indicating whether a subcarrier to which transmission data is allocated (hereinafter, referred to as an “available subcarrier”) is an even subcarrier or an odd subcarrier. The subcarrier mapping unit 230 is an example of a mapping unit.

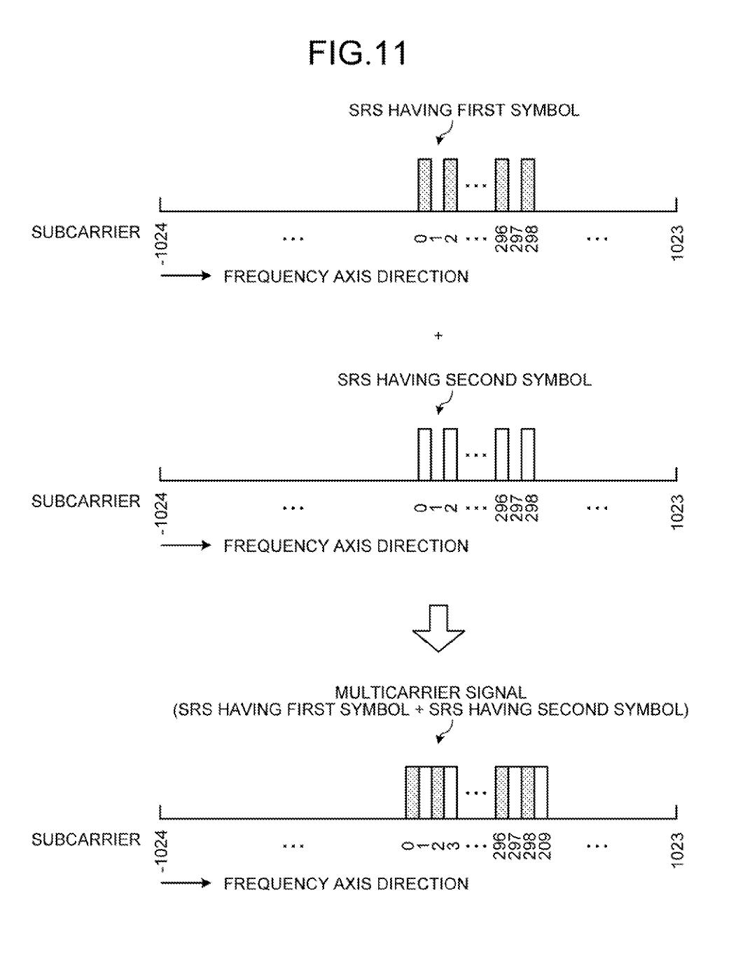

The process performed by the subcarrier mapping unit 230 will be described in detail below with reference to FIG. 11. FIG. 11 is a schematic diagram illustrating a process performed by the subcarrier mapping unit 230. In the following, it is assumed that the subcarriers to which transmission data are allocated are previously determined (hereinafter, referred to as “transmission subcarriers”) and it is assumed that the transmission subcarriers of the SRSs having the first symbol are even subcarriers. Furthermore, it is assumed that the transmission subcarriers of the SRSs having the second symbol are also even subcarriers.

If the transmission data are 2-symbol SRSs, the subcarrier mapping unit 230 allocates, to the subcarriers, the transmission data such that the SRSs having the first symbol and the SRSs having the second symbol are alternately arranged in the frequency axis direction. For example, as illustrated in FIG. 11, because the transmission subcarriers to which the SRSs having the first symbol are allocated are the even subcarriers, the subcarrier mapping unit 230 allocates the transmission data on the SRSs having the first symbol to the even subcarriers. In contrast, because the transmission subcarriers to which the SRS having the second symbol are allocated are the even subcarriers, the subcarrier mapping unit 230 allocates the transmission data on the SRSs having the second symbol to the odd subcarriers by shifting the subject transmission data by one subcarrier in the frequency axis direction. In this way, a multicarrier signal is created by allocating the SRSs having the first symbol and the SRSs having the second symbol to the subcarriers continuous in the frequency axis direction. Then, the subcarrier mapping unit 230 outputs the multicarrier signal to the IFFT computing unit 240.

Furthermore, the subcarrier mapping unit 230 notifies the control unit 270 of available subcarrier information indicating whether available subcarriers are even subcarriers or odd subcarriers. In the example illustrated in FIG. 11, the subcarrier mapping unit 230 notifies the control unit 270 of the available subcarrier information indicating that the available subcarriers for the SRSs having the first symbol are even subcarriers. In contrast, the subcarrier mapping unit 230 notifies the control unit 270 of the available subcarrier information indicating that the available subcarriers for the SRSs having the second symbol are odd subcarriers.

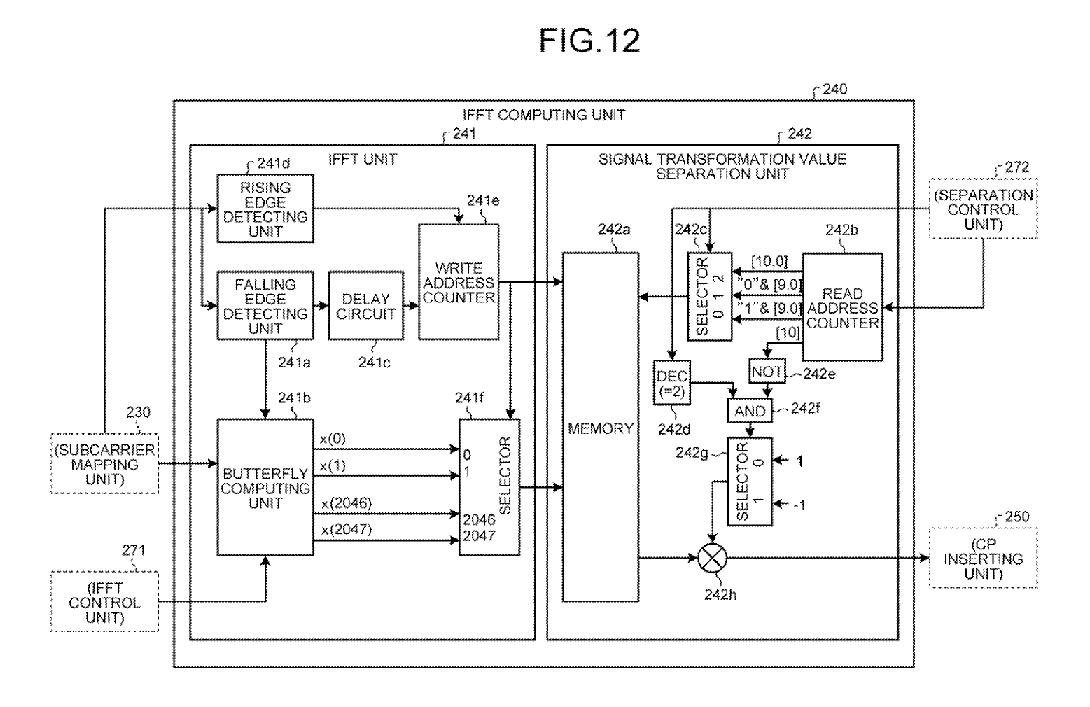

A description will be given here by referring back to FIG. 10. The IFFT computing unit 240 includes an IFFT unit 241 and a signal transformation value separation unit 242. FIG. 12 is a block diagram illustrating an example configuration of the IFFT computing unit 240. In the following, the configuration of the IFFT computing unit 240 will be described in detail with reference to FIG. 12.

The IFFT unit 241 performs inverse Fourier transformations on multicarrier signals that are output from the subcarrier mapping unit 230, thereby obtaining signal transformation values continuous in the time axis direction. Specifically, the IFFT unit 241 includes a falling edge detecting unit 241a, a butterfly computing unit 241b, a delay circuit 241c, a rising edge detecting unit 241d, a write address counter 241e, and a selector 241f.

The IFFT unit 241 sequentially receives, from the subcarrier mapping unit 230, the transmission data constituting the multicarrier signal. The transmission data received by the IFFT unit 241 is output to the butterfly computing unit 241b.

The falling edge detecting unit 241a detects a falling edge of an enable signal that is output from the subcarrier mapping unit 230 when the multicarrier signal is output. Then, if the falling edge detecting unit 241a detects a falling edge of an enable signal, the falling edge detecting unit 241a outputs the detected signal to the butterfly computing unit 241b and the delay circuit 241c.

The butterfly computing unit 241b includes butterfly computing elements (Buts) having multiple stages that perform, in stages, butterfly computation on the transmission data received from the subcarrier mapping unit 230 if a detection signal is received from the falling edge detecting unit 241a. It is assumed that the butterfly computing unit 241b according to the embodiment includes the Buts having 11 stages in total that perform butterfly computation on 2048 transmission data constituting the multicarrier signal. In each of the Buts having the first to the tenth stages from among 11 stages in total included in the butterfly computing unit 241b, normal butterfly computation including multiplication by a twiddle factor w and cross calculation is performed similarly to the Buts 10 illustrated in FIG. 4. In contrast, similarly to the Buts 30a illustrated in FIG. 8, the selectors 31 are arranged in each of the Buts in the 11^{th} stage that is the last stage.

The butterfly computing unit 241b switches computation target data that is the target of the butterfly computation performed, using the selectors 31, by each of the Buts in the last stage. In normal operations, the butterfly computing unit 241b allows each of the Buts in the last stage to perform normal butterfly computation.

Specifically, in normal operations, in each of the Buts in the last stage, the normal butterfly computation including multiplication by a twiddle factor w and cross calculation is performed.

Furthermore, if the butterfly computing unit 241b continuously transmits 2-symbol SRSs, the butterfly computing unit 241b switches the selectors 31 to set the computation target data subjected to the butterfly computation performed by each of the Buts in the last stage to “0”. Then, the butterfly computing unit 241b allows each of the Buts in the last stage to perform the butterfly computation by using the computation target data that is set to “0” by the selectors 31. Then, the butterfly computing unit 241b outputs, to the selector 241f and as signal transformation values continuous in the time axis direction, 2048 computation values x(0) to x(2047) obtained by performing the butterfly computation by each of the Buts in the last stage. Furthermore, the butterfly computing unit 241b switches the selectors 31 in accordance with the SEL signal supplied from an IFFT control unit 271, which will be described later, in the control unit 270.

The delay circuit 241c delays the detection signal received from the falling edge detecting unit 241a by the time corresponding to the processing time performed by the butterfly computing unit 241b. Then, the delay circuit 241c outputs, to the write address counter 241e, the signal obtained by delaying the detection signal by the time corresponding to the processing time performed by the butterfly computing unit 241b. The signal obtained by delaying the detection signal by the time corresponding to the processing time performed by the butterfly computing unit 241b becomes a trigger for the start of a counting process performed by the write address counter 241e.

The rising edge detecting unit 241d detects the rising of the enable signal that is output from the subcarrier mapping unit 230 when the multicarrier signal is output. Then, if the rising edge detecting unit 241d detects the rising of the enable signal, the rising edge detecting unit 241d outputs the detection signal to the write address counter 241e.

The write address counter 241e is a counter that has 2048 counts per cycle. If the write address counter 241e receives, from the delay circuit 241c, the trigger for the start of the counting process, the write address counter 241e creates count values 0 to 2047. Furthermore, if the write address counter 241e receives a detection signal from the rising edge detecting unit 241d, the write address counter 241e resets the count value to 0. Then, the write address counter 241e sequentially outputs the created count values to the selector 241f and to a memory 242a that will be described later and in the signal transformation value separation unit 242. The count values that are input from the write address counter 241e to the memory 242a become addresses in the memory 242a.

The selector 241f sequentially selects, in accordance with the count values input from the write address counter 241e, the signal transformation values x(0) to x(2047) on the time axis received from the butterfly computing unit 241b. Then, the selector 241f sequentially outputs the selected signal transformation values to the memory 242a. Accordingly, if 2-symbol SRSs are continuously transmitted, first-half signal transformation values x(0) to x(1023) from among the signal transformation values x(0) to x(2047) are output to the memory 242a as signal transformation values associated with the subcarriers to which the SRSs having the first symbol are allocated. In contrast, second-half transformation values x(1024) to x(2047) are output to the memory 242a as the signal transformation values associated with the subcarriers to which the SRSs having the second symbol are allocated.

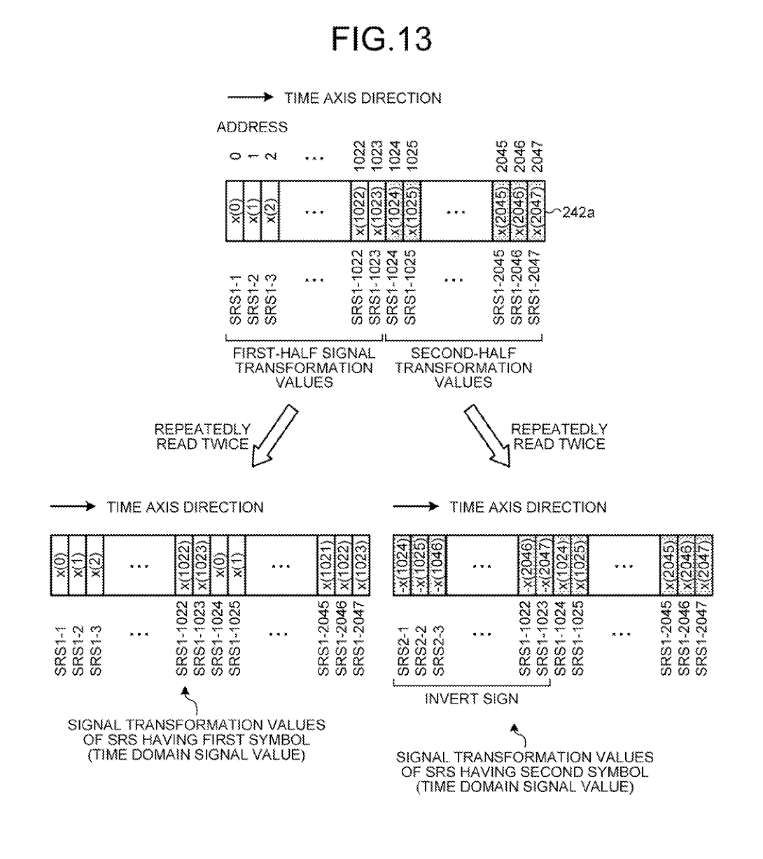

The signal transformation value separation unit 242 separates the signal transformation values output from the IFFT unit 241 into the signal transformation values associated with the subcarriers, to which the SRSs having the first symbol are allocated, and the signal transformation values associated with the subcarriers, to which the SRSs having the second symbol are allocated. FIG. 13 is a schematic diagram illustrating a process performed by the signal transformation value separation unit 242. In the following, a process preformed by the signal transformation value separation unit 242 will be described in detail with reference to FIG. 13.

First, as illustrated in the upper portion of FIG. 13, the signal transformation value separation unit 242 stores signal transformation values x(0) to x(2047) output from the IFFT unit 241 in the memory 242a for addresses associated with the identification numbers of the signal transformation values continuous in the time axis direction. From among the signal transformation values stored in the memory 242a, the first-half signal transformation values x(0) to x(1023), whose first-half identification numbers (i.e., addresses) are the first half, are the signal transformation values associated with the subcarriers to which the SRSs having the first symbol are allocated. Furthermore, from among the signal transformation values stored in the memory 242a, the second-half transformation values x(1024) to x(2047), whose addresses are the second half, are the signal transformation values associated with the subcarriers to which the SRSs having the second symbol are allocated.

Then, from among the signal transformation values stored in the memory 242a, the signal transformation value separation unit 242 repeatedly reads the first-half signal transformation values x(0) to x(1023) twice. At this time, as illustrated in the lower portion of FIG. 13, the signal transformation value separation unit 242 concatenates the first-half signal transformation values x(0) to x(1023), which are read at the second time, with the end of the first-half signal transformation values x(0) to x(1023), which are read at the first time. Accordingly, signal transformation values associated with the subcarriers, to which the SRSs having the first symbol are allocated, are created on the time axis by an amount corresponding to one symbol. Hereinafter, a signal transformation value corresponding to one symbol on the time axis is referred to as a time domain signal value.

Subsequently, from among the signal transformation values stored in the memory 242a, the signal transformation value separation unit 242 repeatedly reads the second-half transformation values x(1024) to x(2047) twice. At this time, as illustrated in the lower portion of FIG. 13, the signal transformation value separation unit 242 inverts the sign of the second-half transformation values that are read at the first time. Then, the signal transformation value separation unit 242 concatenates the second-half transformation values x(1024) to x(2047), which are read at the second time, with the end of the second-half transformation values −x(1024) to −x(2047) whose sign is inverted. Accordingly, time domain signal values associated with the subcarriers, to which SRSs having the second symbol are allocated, are created.

A description will be given here by referring back to FIG. 12. The signal transformation value separation unit 242 includes the memory 242a, a read address counter 242b, a selector 242c, a decoder (DEC) 242d, a NOT circuit 242e, an AND circuit 242f, a selector 242g, and a multiplier 242h.

The memory 242a stores therein the signal transformation values x(0) to x(2047), which are received from the selector 241f and are obtained, as addresses, on the basis of the count values input from the write address counter 241e. Accordingly, the signal transformation values x(0) to x(2047) are stored in the memory 242a in time series. From among the signal transformation values stored in the memory 242a, the first-half signal transformation values x(0) to x(1023), whose identification numbers (i.e., addresses) are the first half, are the signal transformation values associated with the subcarriers to which the SRSs having the first symbol are allocated. Furthermore, from among the signal transformation values stored in the memory 242a, the second-half transformation values x(1024) to x(2047), whose addresses are the second half, are the signal transformation values associated with the subcarriers to which the SRSs having the second symbol are allocated.

Furthermore, the memory 242a receives an input of a read address from the selector 242c. Then, the memory 242a outputs, to the multiplier 242h, a signal transformation value associated with the received read address.

The read address counter 242b is a counter that has 2048 counts per cycle. If the read address counter 242b receives a read-start signal from a separation control unit 272, which will be described later, in the control unit 270, the read address counter 242b creates count values 0 to 2047. Then, the read address counter 242b outputs the created count values to the selector 242c and the NOT circuit 242e.

The selector 242c selects a count value received from the read address counter 242b in accordance with the value of the SEL signal that is input from the separation control unit 272 and then outputs the selected count value as a read address to the memory 242a. Specifically, if the SEL signal received from the separation control unit 272 is “0”, the selector 242c selects all of the count values 0 to 2047 and outputs all of the selected count values as read addresses to the memory 242a. At this time, if the SEL signal is “0”, this state indicates that a signal other than the 2-symbol SRSs is transmitted.

Furthermore, if the SEL signal that is input from the separation control unit 272 is “1”, the selector 242c repeatedly selects the first-half count values (0 to 1023) twice from among all of the count values and outputs the selected first-half count values as the read addresses to the memory 242a. At this time, if the SEL signal is “1”, this state indicates that the SRS having the first symbol is transmitted from among the 2-symbol SRSs that are continuously transmitted.

Furthermore, if the SEL signal that is input from the separation control unit 272 is “2”, the selector 242c repeatedly selects the second-half count values (1024 to 2047) twice from among all of the count values and outputs the selected second-half count values as the read addresses to the memory 242a. At this time, if the SEL signal is “2”, this state indicates that the SRSs having the second symbol are transmitted from among the 2-symbol SRSs that are continuously transmitted.

The decoder 242d receives an input of a SEL signal from the separation control unit 272. If the input SEL signal is “2”, the decoder 242d outputs “1” to the AND circuit 242f. If the SEL signal is “0” or “1”, the decoder 242d outputs “0” to the AND circuit 242f. Specifically, the decoder 242d outputs “1” to the AND circuit 242f only when the SRSs having the second symbol are transmitted from among the 2-symbol SRSs that are continuously transmitted.

The NOT circuit 242e only receives the most significant bit from among the count values output from the read address counter 242b, inverts the received most significant bit, and outputs it to the AND circuit 242f. At this time, if the count values are the first-half count values (0 to 1023), the most significant bit becomes “0”, whereas if the count values are the second-half count values (1024 to 2047), the most significant bit becomes “1”. Specifically, if the first-half count values (0 to 1023) are output from the read address counter 242b as the read addresses, the NOT circuit 242e receives “0” as the most significant bit; therefore, the NOT circuit 242e outputs “1”, i.e., inverted “0”, to the AND circuit 242f. In contrast, if the second-half count values (1024 to 2047) are transmitted from the read address counter 242b as the read addresses, the NOT circuit 242e receives “1” as the most significant bit; therefore, the NOT circuit 242e outputs “0”, i.e., inverted “1”, to the AND circuit 242f.

If an input from the decoder 242d is “1” and an input from the NOT circuit 242e is also “1”, the AND circuit 242f outputs “1” to the selector 242g as the SEL signal. In contrast, if an input from the decoder 242d or the NOT circuit 242e is “0”, the AND circuit 242f outputs “0” to the selector 242g as the SEL signal. Specifically, if the SRSs having the second symbol are transmitted from among continuous 2-symbol SRSs and the read addresses (0 to 1023) are output from the read address counter 242b, “1” is input to the selector 242g as the SEL signal.

The selector 242g selects, in accordance with the value of the SEL signal input from the AND circuit 242f, an output value of “1” or “−1” and outputs the selected output value to the multiplier 242h. Specifically, if the SEL signal is “0”, the selector 242g selects “1” and outputs “1” to the multiplier 242h. In contrast, if the SEL signal is “1”, the selector 242g selects “−1” and outputs “−1” to the multiplier 242h. Specifically, if the SRSs having the second symbol are transmitted from among continuous 2-symbol SRSs and the read addresses (0 to 1023) are output from the read address counter 242b, “−1” is output to the multiplier 242h.

The multiplier 242h receives, from the selector 242g, an output value of “1” or “−1”. The multiplier 242h reads, from the memory 242a, a signal transformation value associated with the read address. Then, the multiplier 242h multiplies the output value of “1” or “−1” by the signal transformation value and outputs the multiplication result to the CP inserting unit 250.

In this way, if the SRSs having the first symbol are transmitted from among the continuous 2-symbol SRSs, the multiplier 242h repeatedly reads the first-half signal transformation values x(0) to x(1023) twice from among the signal transformation values stored in the memory 242a. At this time, the multiplier 242h concatenates the first-half signal transformation values x(0) to x(1023), which are read at the second time, with the end of the first-half signal transformation values x(0) to x(1023), which are read at the first time. Accordingly, the time domain signal values associated with the subcarriers, to which the SRSs having the first symbol are allocated, are created and are output to the CP inserting unit 250.

Similarly, if the SRSs having the second symbol are transmitted from among the continuous 2-symbol SRSs, the multiplier 242h repeatedly reads the second-half transformation values x(1024) to x(2047) twice from among the signal transformation values stored in the memory 242a. At this time, the multiplier 242h multiplies “−1” by the second-half transformation values x(1024) to x(2047), which are read at the first time, and inverts the sign thereof. Then, the multiplier 242h concatenates the second-half transformation values x(1024) to x(2047), which are read at the second time, with the end of the second-half transformation values −x(1024) to −x(2047), whose sign is inverted. Accordingly, the time domain signal values associated with the subcarriers, to which the SRSs having the second symbol are allocated, are created and are output to the CP inserting unit 250.

A description will be given here by referring back to FIG. 10. The CP inserting unit 250 uses, as a CP, a certain time period at the end of the time domain signal that is input from the signal transformation value separation unit 242 and inserts the CP into the top of the time domain signal.

The subcarrier shifting unit 260 multiplies a twiddle factor by the time domain signal, into which the CP is inserted by the CP inserting unit 250, and performs a frequency shift process in the high frequency or the low frequency direction of the frequency axis by half of the bandwidth of each subcarrier. In the following, the frequency shift process for shifting subcarriers in the high frequency direction of the frequency axis by half of the bandwidth of each subcarrier may sometimes be referred to as a “+½ subcarrier shifting process”. Furthermore, the frequency shift process for shifting subcarriers in the low frequency direction of the frequency axis by half of the bandwidth of each subcarrier may sometimes be referred to as a “−½ subcarrier shifting process”. Furthermore, in accordance with the determination result input from a subcarrier shift determining unit 273, which will be described later, in the control unit 270, the subcarrier shifting unit 260 determines a process to be performed between the +½ subcarrier shifting process and the −½ subcarrier shifting process. The process performed by the subcarrier shifting unit 260 will be described in detail later.

The control unit 270 controls the IFFT computing unit 240 and the subcarrier shifting unit 260. Specifically, the control unit 270 includes the IFFT control unit 271, the separation control unit 272, and the subcarrier shift determining unit 273.

The IFFT control unit 271 switches computation target data that is the target of the butterfly computation performed by each of the Buts in the last stage arranged in the butterfly computing unit 241b in the IFFT unit 241. For example, by supplying “0” as the SEL signal to the selectors 31 arranged in each of the Buts in the last stage included in the butterfly computing unit 241b, the IFFT control unit 271 allows each of the Buts in the last stage to perform the normal butterfly computation.

In contrast, if 2-symbol SRSs are continuously transmitted, the IFFT control unit 271 switches the selectors 31 by supplying “1” as the SEL signal to the selectors 31 arranged in each of the Buts in the last stage included in the butterfly computing unit 241b. If the selectors 31 are switched in this way, the butterfly computing unit 241b sets the computation target data of the butterfly computation performed by each of the Buts in the last stage to “0”.

The separation control unit 272 outputs a read start signal to the read address counter 242b in the signal transformation value separation unit 242, thereby the separation control unit 272 starts creating the count values (read addresses). Furthermore, the separation control unit 272 outputs “0”, “1”, or “2” as the SEL signal to both the selector 242c and the decoder 242d.

The subcarrier shift determining unit 273 holds the transmission subcarriers. The subcarrier shift determining unit 273 receives available subcarrier information from the subcarrier mapping unit 230. Then, the subcarrier shift determining unit 273 determines whether an available subcarrier indicated by the available subcarrier information matches the transmission subcarrier that is retained by the subcarrier shift determining unit 273. Then, the subcarrier shift determining unit 273 outputs the determination result to the subcarrier shifting unit 260.

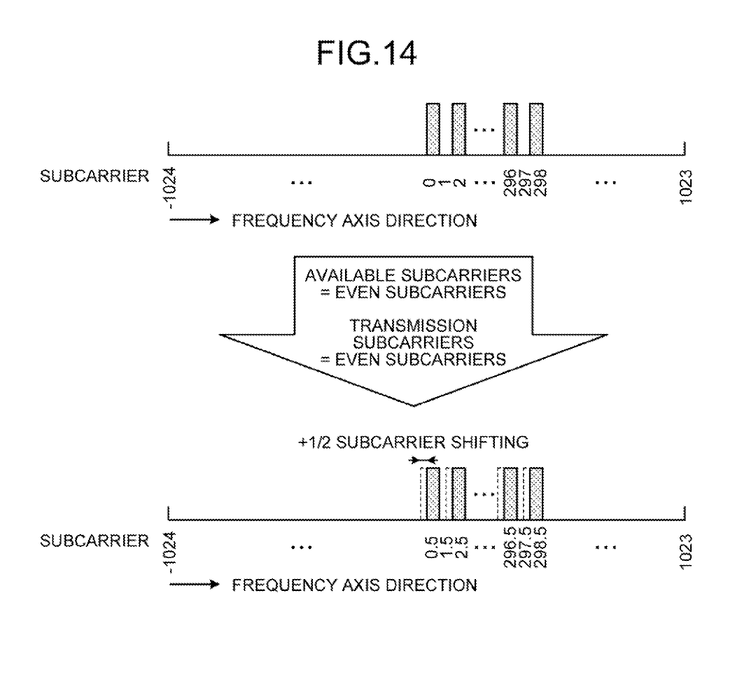

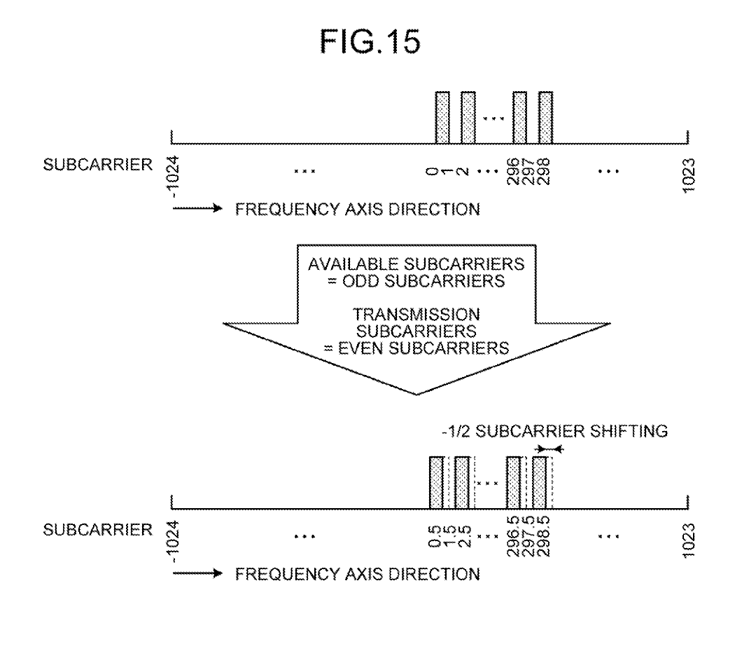

In the following, the process performed by the subcarrier shifting unit 260 will be described in detail with reference to FIGS. 14 and 15. FIGS. 14 and 15 are schematic diagrams each illustrating a process performed by the subcarrier shifting unit 260. In FIGS. 14 and 15, it is assumed that transmission subcarriers are the even subcarriers. Furthermore, in FIG. 14, it is assumed that the available subcarriers are the even subcarriers. In FIG. 15, it is assumed that the available subcarriers are the odd subcarriers.

If the subcarrier shifting unit 260 receives, from the subcarrier shift determining unit 273, a determination result indicating that the even subcarriers corresponding to the available subcarriers match the transmission subcarriers, the subcarrier shifting unit 260 performs the +½ subcarrier shifting process, as illustrated in FIG. 14.

In contrast, if the subcarrier shifting unit 260 receives, from the subcarrier shift determining unit 273, a determination result indicating that the odd subcarriers corresponding to the available subcarriers do not match the transmission subcarriers, the subcarrier shifting unit 260 inverts the shift direction of the frequency shift, as illustrated in FIG. 15. Then, the subcarrier shifting unit 260 performs the −½ subcarrier shifting process.

The transmission data creating unit 210, the DFT unit 220, the subcarrier mapping unit 230, the IFFT computing unit 240, the CP inserting unit 250, the subcarrier shifting unit 260, and the control unit 270 described above are, for example, electronic circuits. Examples of the electronic circuits include an integrated circuit, such as an application specific integrated circuit (ASIC) and a field programmable gate array (FPGA), a central processing unit (CPU), or a micro processing unit (MPU). Furthermore, the memory 242a is, for example, a semiconductor memory device, such as a random access memory (RAM), read only memory (ROM), and a flash memory, or a storage device, such as a hard disk, and an optical disk.

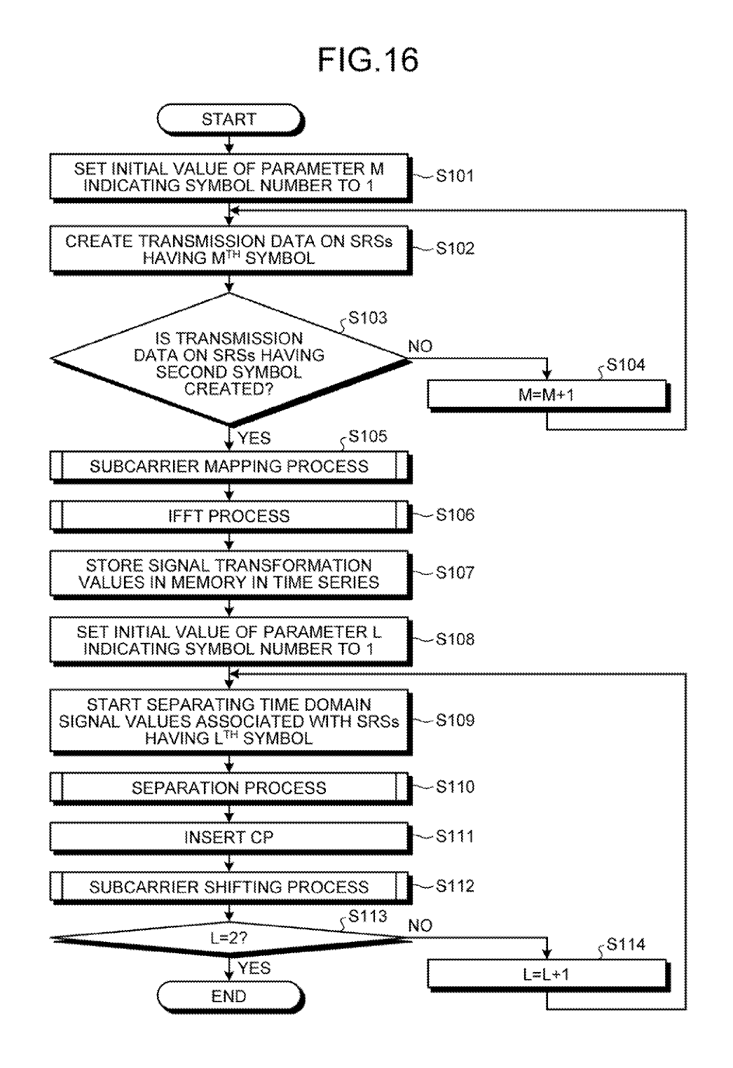

The flow of a transmission process performed by the transmission processing unit 200 according to the embodiment will be described below with reference to FIG. 16. FIG. 16 is a flowchart illustrating the flow of a transmission process performed by the transmission processing unit 200 according to the embodiment. In the following, it is assumed that the 2-symbol SRSs are continuously transmitted by the transmission processing unit 200.

As illustrated in FIG. 16, if the transmission data creating unit 210 in the transmission processing unit 200 receives, from the higher layer 24, an instruction to transmit continuous 2-symbol SRSs, the transmission data creating unit 210 sets the initial value of the parameter M indicating the symbol number to 1 (Step S101). The transmission data creating unit 210 creates transmission data on SRSs having an M^{th} symbol (Step S102). The transmission data creating unit 210 determines whether transmission data on the SRSs having the second symbol is created (Step S103).

If the transmission data creating unit 210 has not created the transmission data on the SRSs having the second symbol yet (No at Step S103), the transmission data creating unit 210 increments M (Step S104) and creates the transmission data on the SRSs having the second symbol (Step S102). In contrast, if the transmission data creating unit 210 creates the transmission data on the SRSs having the second symbol (Yes at Step S103), the process proceeds to Step S105.

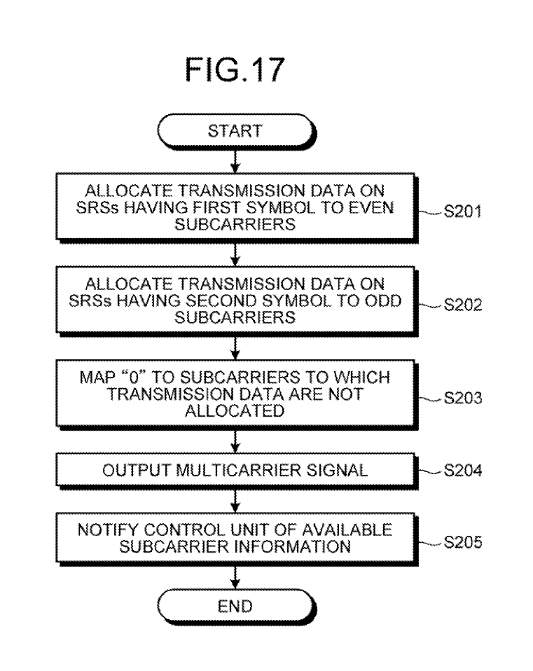

The subcarrier mapping unit 230 receives an input of the transmission data from the transmission data creating unit 210. The subcarrier mapping unit 230 allocates the received SRSs having the first symbol and the SRSs having the second symbol to subcarriers continuous in the frequency axis direction (Step S105). The subcarrier mapping process performed at Step S105 will be described later with reference to FIG. 17.

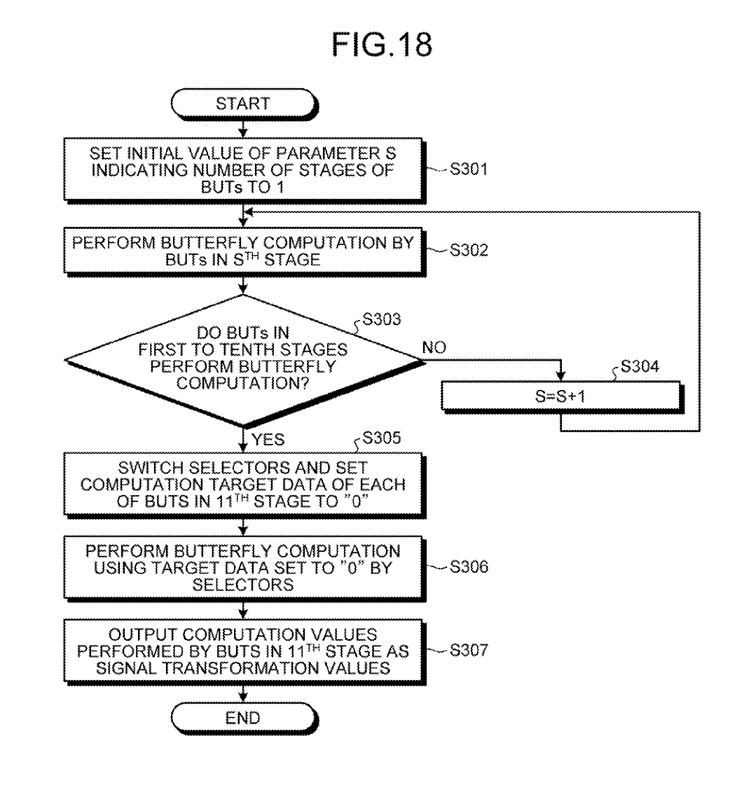

Then, the IFFT unit 241 in the IFFT computing unit 240 receives an input of a multicarrier signal created by the subcarrier mapping process. The IFFT unit 241 performs an inverse Fourier transformation on the multicarrier signal and obtains signal transformation value continuous in the time axis direction (Step S106). The IFFT process performed at Step S106 will be described later with reference to FIG. 18.

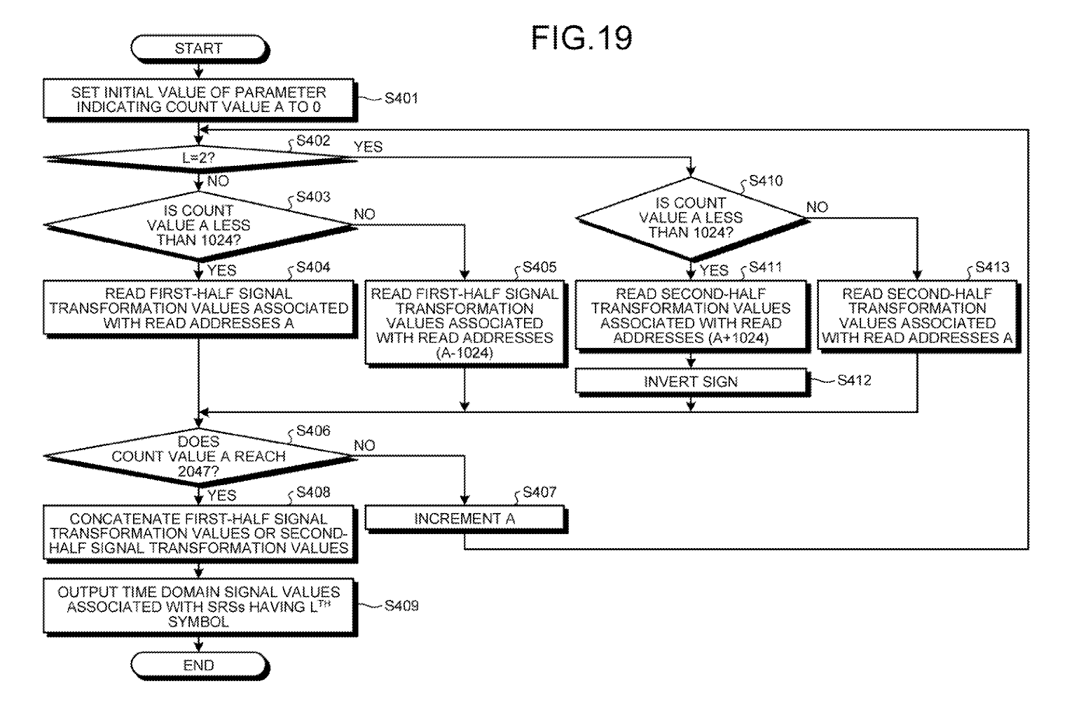

Then, the signal transformation value separation unit 242 stores, in the memory 242a in time series, the signal transformation values that are input from the IFFT unit 241 (Step S107). The signal transformation value separation unit 242 sets the initial value of the parameter L indicating the symbol number to 1 (Step S108). The signal transformation value separation unit 242 starts separating the time domain signal values associated with the SRSs having an L^{th} symbol (Step S109). The signal transformation value separation unit 242 separates the signal transformation values stored in the memory 242a from the time domain signal values associated with the SRSs having the L^{th} symbol (Step S110). The separation process performed at Step S110 will be described later with reference to FIG. 19.

Then, the CP inserting unit 250 inserts a CP into a time domain signal that is input from the signal transformation value separation unit 242 (Step S111).

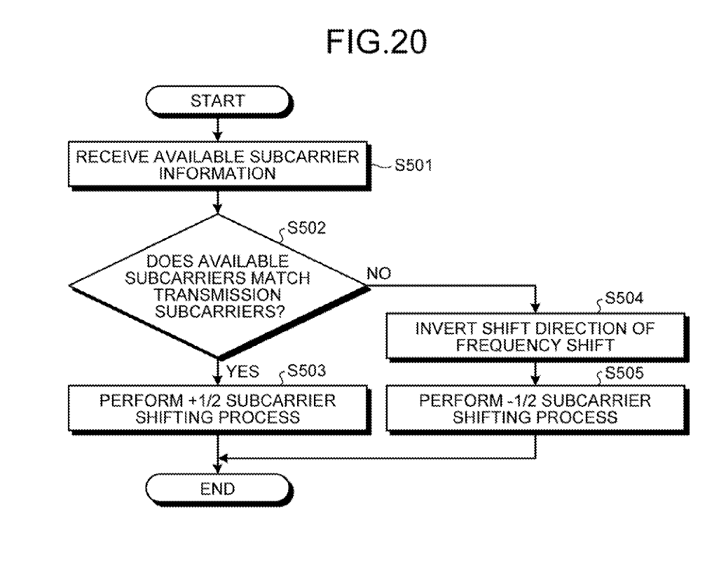

Then, the subcarrier shifting unit 260 performs the frequency shift process on the time domain signal, into which the CP is inserted, in the high frequency or the low frequency direction of the frequency axis by an amount corresponding to half of the bandwidth of each subcarrier (Step S112). The subcarrier shifting process performed at Step S112 will be described later with reference to FIG. 20.

Then, the signal transformation value separation unit 242 determines whether the signal transformation value separation unit 242 has already performed the separation process on the time domain signals associated with the SRSs having the second symbol (Step S113). If the signal transformation value separation unit 242 has not performed the separation process on the time domain signals associated with the SRSs having the second symbol (No at Step S113), the signal transformation value separation unit 242 increments L (Step S114) and starts separating the time domain signals associated with the SRSs having the second symbol (Step S109). In contrast, if the signal transformation value separation unit 242 finished separating the time domain signals associated with the SRSs having the second symbol (Yes at Step S113), the signal transformation value separation unit 242 ends the transmission process.

In the following, the flow of the subcarrier mapping process performed by the subcarrier mapping unit 230 according to the embodiment will be described with reference to FIG. 17. FIG. 17 is a flowchart illustrating the flow of a subcarrier mapping process performed by the subcarrier mapping unit 230 according to the embodiment.

As illustrated in FIG. 17, the subcarrier mapping unit 230 allocates transmission data on the SRSs having the first symbol to the even subcarriers (Step S201). The subcarrier mapping unit 230 allocates the transmission data on the SRSs having the second symbol to the odd subcarriers (Step S202). The subcarrier mapping unit 230 allocates “0” to subcarriers to which the transmission data are not allocated (Step S203). In this way, by alternately allocating the SRSs having the first symbol and the SRSs having the second symbol to the subcarriers in the frequency axis direction, the multicarrier signal is created. Then, the subcarrier mapping unit 230 outputs the created multicarrier signal to the IFFT computing unit 240 (Step S204).

Then, the subcarrier mapping unit 230 notifies the control unit 270 of available subcarrier information indicating whether the available subcarriers are the even subcarriers or the odd subcarriers (Step S205) and ends the subcarrier mapping process.

In the following, the flow of the IFFT process performed by the IFFT unit 241 according to the embodiment will be described with reference to FIG. 18. FIG. 18 is a flowchart illustrating the flow of an IFFT process performed by the IFFT unit 241 according to the embodiment.

As illustrated in FIG. 18, the IFFT unit 241 sets the initial value of the parameter S that indicates the number of stages of the Buts to 1 (Step S301). The IFFT unit 241 allows the Buts in an S^{th} stage to perform the butterfly computation (Step S302). Ten, the IFFT unit 241 determines whether the Buts in the first to the tenth stages perform the butterfly computation (Step S303).

If Buts in the first to the tenth stages do not perform the butterfly computation (No at Step S303), the IFFT unit 241 increments S (Step S304), the IFFT unit 241 allows the Buts in the S^{th} stage to perform the butterfly computation (Step S302).

In contrast, if the Buts in the first to the tenth stages perform the butterfly computation (Yes at Step S303), the IFFT unit 241 switches the selectors 31 and sets the computation target data in each of the Buts in the 11^{th} stage, which is the last stage, to “0” (Step S305). Then, by using the computation target data that is set to “0” by the selectors 31, the IFFT unit 241 allows each of the Buts in the 11^{th} stage to perform the butterfly computation (Step S306). Then, the IFFT unit 241 outputs, to the signal transformation value separation unit 242, 2048 computation values x(0) to x(2047), which are obtained from the butterfly computation performed by each of the Buts in the last stage, as signal transformation values continuous in the time axis direction (Step S307).

In the following, the flow of the separation process performed by the signal transformation value separation unit 242 according to the embodiment will be described with reference to FIG. 19. FIG. 19 is a flowchart illustrating the flow of a separation process performed by the signal transformation value separation unit 242 according to the embodiment.

As illustrated in FIG. 19, the signal transformation value separation unit 242 sets the initial value of the parameter A indicating a count value to 0 and creates a count value 0 (Step S401). If the signal transformation value separation unit 242 reads, from the memory 242a, the signal transformation values associated with the subcarriers to which SRSs having the first symbol are allocated (No at Step S402), the signal transformation value separation unit 242 determines whether the count value A is less than 1024 (Step S403).

If the count value A is less than 1024 (Yes at Step S403), the signal transformation value separation unit 242 reads, from the memory 242a, the first-half signal transformation values x(0) to x(1023) associated with the read addresses A (Step S404). In contrast, if the count value A is equal to or greater than 1024 (No at Step S403), the signal transformation value separation unit 242 again reads, from the memory 242a, the first-half signal transformation values x(0) to x(1023) associated with the read addresses (A-1024) (Step S405).

Then, if the count value A does not reach 2047 (No at Step S406), the signal transformation value separation unit 242 increment A (Step S407) returns the process to Step S402. In contrast, if the count value A reaches 2047 (Yes at Step S406), the signal transformation value separation unit 242 concatenates the first-half signal transformation values read at Step S405 with the end of the first-half signal transformation values read at Step S404 (Step S408). Accordingly, the time domain signal values associated with the subcarriers, to which the SRSs having the first symbol are allocated, are created and are output to the CP inserting unit 250 (Step S409).

Furthermore, if the signal transformation value separation unit 242 reads, from the memory 242a, the signal transformation values associated with the subcarriers to which the SRSs having the second symbol are allocated (Yes at Step S402), the signal transformation value separation unit 242 determines whether the count value A is less than 1024 (Step S410).

If the count value A is less than 1024 (Yes at Step S410), the signal transformation value separation unit 242 reads, from the memory 242a, the second-half transformation values x(1024) to x(2047) associated with the read addresses (A+1024) (Step S411). Then, the signal transformation value separation unit 242 multiplies “−1” by the second-half transformation values x(1024) to x(2047) that are read from the memory 242a and inverts the sign thereof (Step S412). In contrast, if the count value A is equal to or greater than 1024 (No at Step S410), the signal transformation value separation unit 242 reads, from the memory 242a, the second-half transformation values x(1024) to x(2047) associated with the read addresses A (Step S413).

Then, if the count value A does not reach 2047 (No at Step S406), the signal transformation value separation unit 242 increments A (Step S407) and the process returns to Step S402. In contrast, if the count value A reaches 2047 (Yes at Step S406), the signal transformation value separation unit 242 concatenates the second-half transformation values, which are read at Step S413, with the end of the second-half transformation values, which are inverted at Step S412 (Step S408). Accordingly, the time domain signal values associated with the subcarriers, to which the SRSs having the second symbol are allocated, are created and are output to the CP inserting unit 250 (Step S409).

In the following, the flow of a subcarrier shifting process performed by the subcarrier shifting unit 260 and the subcarrier shift determining unit 273 according to the embodiment will be described with reference to FIG. 20. FIG. 20 is a flowchart illustrating the flow of the subcarrier shifting process performed by the subcarrier shifting unit 260 and the subcarrier shift determining unit 273 according to the embodiment.

As illustrated in FIG. 20, the subcarrier shift determining unit 273 receives an input of the available subcarrier information from the subcarrier mapping unit 230 (Step S501). Then, the subcarrier shift determining unit 273 determines whether the available subcarriers indicated by the available subcarrier information match the transmission subcarriers retained in the subcarrier shift determining unit 273 (Step S502). Then, the subcarrier shift determining unit 273 outputs the determination result to the subcarrier shifting unit 260.

If the subcarrier shifting unit 260 receives, from the subcarrier shift determining unit 273, the determination result indicating that the available subcarriers match the transmission subcarriers (Yes at Step S502), the subcarrier shifting unit 260 performs the +½ subcarrier shifting process (Step S503).

In contrast, if the subcarrier shifting unit 260 receives, from the subcarrier shift determining unit 273, the determination result indicating that the available subcarriers do not match the transmission subcarriers (No at Step S502), the subcarrier shifting unit 260 inverts the shift direction of the frequency shift (Step S504). Then, the subcarrier shifting unit 260 performs the −½ subcarrier shifting process (Step S505).

As described above, with the wireless communication apparatus 20 according to the embodiment, when continuously transmits 2-symbol SRSs, the wireless communication apparatus 20 performs an inverse Fourier transformation on a multicarrier signal, in which the 2-symbol SRSs are allocated to subcarriers continuous in the frequency axis direction, and obtains signal transformation values. Then, the wireless communication apparatus 20 separates the obtained signal transformation values into the signal transformation values associated with the SRSs having the first symbol and the signal transformation values associated with the SRSs having the second symbol. Accordingly, the wireless communication apparatus 20 according to the embodiment can eliminate unnecessary calculation performed in the Buts and reduce the number of times an inverse Fourier transformation is performed from two to one. Consequently, it is possible to reduce the load related to the inverse Fourier transformation performed when 2-symbol SRSs are continuously transmitted, and thus possible to reduce the electrical power consumption of the apparatus.

Furthermore, the wireless communication apparatus 20 according to the embodiment creates a multicarrier signal in which the SRSs having the first symbol and the SRSs having the second symbol are allocated to the subcarriers such that the SRSs are alternately arranged in the frequency axis direction. Accordingly, according to the embodiment, it is possible to allocate transmission data on the SRSs having the second symbol to subcarriers to which transmission data on the SRSs having the first symbol are not allocated, and thus it is possible to efficiently transmit two SRSs using a single multicarrier signal.

Furthermore, with the wireless communication apparatus 20 according to the embodiment, the selectors 31 are arranged in the last stage, from among multiple stages, of each of the Buts that performs, in stages, butterfly computation on the multicarrier signal. Then, by using the computation target data of 0 set by the selectors 31, the wireless communication apparatus 20 calculates, as signal transformation values, computation values obtained from the butterfly computation performed by each of the Buts in the last stage. Accordingly, according to the embodiment, by performing a simple process, i.e., the switching of the selectors 31, it is possible to perform, in stages, the butterfly computation by avoiding the interference of the 2-symbol SRSs included in the multicarrier signal, thus improving the efficiency of inverse Fourier transformations.

Furthermore, the wireless communication apparatus 20 according to the embodiment creates signal transformation values associated with the SRSs having the first symbol by concatenating the first-half signal transformation values, which are read at the second time from the memory 242a, with the end of the first-half signal transformation values, which are read at the first time. Accordingly, according to the embodiment, it is possible to efficiently separate the signal transformation values in a single multicarrier signal, to which continuous 2-symbol SRSs are allocated, from the signal transformation values associated with the SRSs having the first symbol.

Furthermore, the wireless communication apparatus 20 according to the embodiment inverts the sign of the second-half transformation values that are read from the memory 242a at the first time. Then, the wireless communication apparatus 20 creates signal transformation values associated with the SRSs having the second symbol by concatenating the second-half transformation values, which are read at the second time from the memory 242a, with the end of the second-half transformation values, whose sign is inverted. Accordingly, according to the embodiment, it is possible to efficiently separate the signal transformation values in a single multicarrier signal, to which continuous 2-symbol SRSs are allocated, from the signal transformation values associated with the SRSs having the second symbol.

Furthermore, with the wireless communication apparatus 20 according to the embodiment, if available subcarriers, to which the SRSs having the first symbol or the SRSs having the second symbol are allocated, do not match a predetermined transmission subcarrier, the wireless communication apparatus 20 inverts the shift direction of the frequency shift. Accordingly, according to the embodiment, it is possible to correct the result of the frequency shift, which is associated with the SRSs allocated to the subcarriers that are different from the predetermined subcarrier, such that the subject frequency shift matches the frequency shift, which is associated with the SRSs allocated to the predetermined subcarrier.

According to an aspect of the multicarrier transmitting apparatus disclosed in the present invention, if two types of reference signals are continuously transmitted, an advantage is provided in that the load applied to inverse Fourier transformations can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A multicarrier transmitting apparatus comprising:
a mapping unit that outputs, when first reference signals and second reference signals continuous in the time axis direction are transmitted, a multicarrier signal in which the first reference signals and the second reference signals are allocated to subcarriers continuous in the frequency axis direction;
an inverse Fourier transformation unit that performs an inverse Fourier transformation on the multicarrier signal output from the mapping unit to output signal transformation values continuous in the time axis direction; and
a signal transformation value separation unit that separates the signal transformation values output from the inverse Fourier transformation unit into signal transformation values associated with subcarriers to which the first reference signals are allocated and signal transformation values associated with subcarriers to which the second reference signals are allocated.

2. The multicarrier transmitting apparatus according to claim 1, wherein the mapping unit outputs the multicarrier signal in which the first reference signals and the second reference signals are allocated to the subcarriers such that the first reference signals and the second reference signals are alternately arranged in the frequency axis direction.

3. The multicarrier transmitting apparatus according to claim 1, wherein
the inverse Fourier transformation unit includes
butterfly computing elements that have multiple stages and that perform, in stages, butterfly computation on the multicarrier signal, and
a selector that is arranged in each of the butterfly computing elements in the last stage from among the butterfly computing elements having the multiple stages and that sets, to zero, computation target data targeted for the butterfly computation that is performed by each of the butterfly computing elements in the last stage, and
the inverse Fourier transformation unit outputs, as the signal transformation values, computation values obtained from the butterfly computation performed by each of the butterfly computing elements in the last stage by using the computation target data that is set to zero by the selector.

4. The multicarrier transmitting apparatus according to claim 1, wherein
the signal transformation value separation unit includes a memory that stores therein the signal transformation values, which are output from the inverse Fourier transformation unit, for identification numbers of the signal transformation values continuous in the time axis direction, and
from among the signal transformation values stored in the memory, the signal transformation value separation unit reads, twice, first-half signal transformation values whose identification numbers are a first half and concatenates the first-half signal transformation values, which are read at a second time, with the end of the first-half signal transformation values, which are read at a first time, to create signal transformation values associated with the subcarriers to which the first reference signals are allocated.

5. The multicarrier transmitting apparatus according to claim 1, wherein
the signal transformation value separation unit includes a memory that stores therein the signal transformation values, which are output from the inverse Fourier transformation unit, for identification numbers of the signal transformation values continuous in the time axis direction, and
from among the signal transformation values stored in the memory, the signal transformation value separation unit reads, twice, second-half transformation values whose identification numbers are a second half, inverts a sign of the second-half transformation values that are read at a first time, and concatenates the second-half transformation values that are read at a second time with the end of the second-half transformation values, whose sign is inverted, to create signal transformation values associated with the subcarriers to which the second reference signals are allocated.

6. The multicarrier transmitting apparatus according to claim 1, further comprising:
a determining unit that determines whether available subcarriers, to which the first reference signals or the second reference signals are allocated by the mapping unit, match transmission subcarriers that are previously specified in accordance with the first reference signals or the second reference signals; and
a subcarrier shifting unit that performs, when the determining unit determines that the available subcarriers match the transmission subcarriers, a frequency shift on the signal transformation values separated by the signal transformation value separation unit by half of a frequency bandwidth of each of the available subcarriers and that inverts, when the determining unit determines that the available subcarriers do not match the transmission subcarriers, a shift direction of the frequency shift.

7. A multicarrier transmitting method performed by a multicarrier transmitting apparatus, the multicarrier transmitting method comprising:
outputting, when first reference signals and second reference signals continuous in the time axis direction, a multicarrier signal in which the first reference signals and the second reference signals are allocated to subcarriers continuous in the frequency axis direction;
outputting signal transformation values in the time axis direction by performing an inverse Fourier transformation on the output multicarrier signal; and
separating the output signal transformation values into signal transformation values associated with the subcarriers to which the first reference signals are allocated and signal transformation values associated with the subcarriers to which the second reference signals are allocated.
